(19) United States
(12) Patent Application Publication
(10) Pub. No.: US 2004/0036990 A1
(43) Pub. Date: Feb. 26, 2004

(54) Light-emitting unit, illumination apparatus and projection display apparatus

(75) Inventor: Kazunari Hanano, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Optical Co., Ltd., Shibuya-ku (JP)

(21) Appl. No.: 10/430,043

(22) Filed: May 6, 2003

(30) Foreign Application Priority Data
May 10, 2002 (JP) 2002-135337

(51) Int. Cl. G02B 5/04

(52) U.S. Cl. 359/831

(57) ABSTRACT

A light-emitting unit comprises a light emitter made of a semiconductor or a light emitter which is of an electron exciting type. The light-emitting unit further comprises a prism array which is arranged in the vicinity of the front of the light emitter and converts output light rays from the light emitter other than those in a predetermined angle range into light rays in the angle range.

### CROSS-REFERENCE TO RELATED APPLICATIONS

This application is based upon and claims the benefit of priority from the prior Japanese Patent Application No. 2002-135337, filed May 10, 2002, the entire contents of which are incorporated herein by reference.

### BACKGROUND OF THE INVENTION

1. Field of the Invention

The present invention relates to a light-emitting unit with the high directivity and the high brightness, which uses a light emitter such as a light emitting diode as a light source. Further, the present invention relates to an illumination apparatus which uses a light emitter, e.g., a light emitting diode as a light source, is bright and has less illumination irregularities, and a projection display apparatus using such an illumination apparatus.

2. Description of the Related Art

A light emitting diode (LED) has various characteristics such as a long duration of life, high color reproduction, high reliability, high-speed responsibility and others. Further, in recent years, realization of the higher brightness has been achieved. Thus, the utilization opportunities of the LED have spread as a substitution for a fluorescent lamp or a white lamp with respect to each of various kinds of applications.

The LED is essentially a diffusion light source having no directivity. Therefore, it is necessary to control the directivity of the radiated light and improve the brightness depending on applications. Thus, various proposals have been made. For example, U.S. Pat. No. 5,592,578 discloses an ambient optical technique which narrows a direction of the light as an observation angle. According to this technique, a lens and an optical element (curved reflecting mirror having a metal paraboloid) are provided in front of the LED chip, the optical element being arranged between the LED chip and the lens.

Furthermore, in recent years, with spread and diversification of AV media such as a personal computer environment, DVD or a digital ground-based TV broadcast, the high picture quality/large screen is oriented. Above all, a projector apparatus which uses an optical modulation element and performs enlarged projection has a small size but the good usability that a screen size can be changed in accordance with the environment, and hence it is active in trade.

As such a projector apparatus, there are disclosed many examples each of which uses as a light source a white lamp with the high brightness such as a xenon lamp, a halogen lamp, a metal halide lamp, an extra-high pressure mercury lamp and others. Usually, the projector apparatus illuminates its optical modulation element such as a liquid crystal panel (LCD) or a two-dimensional micro-polarizing mirror array while narrowing a light flux diameter of the output light from such a white lamp in accordance with an element size of the optical modulation element through an ultra-violet ray and infra-red ray (IR-UV) cut filter.

At the present day, a white discharge lamp which is most general as a light source of the projector apparatus has problems that a circuit scale of a power supply circuit system is large since a high voltage is required in order to discharge electricity and that a temperature tends to increase as well as a drawback of deterioration of the light utilization efficiency. Moreover, by using a rod integrator or a fly-eye integrator between the white discharge lamp and an illumination lens in order to reduce illumination irregularities due to a brightness distribution at a arc part, an irregularity elimination function is provided to the illumination optical system. Providing such an irregularity elimination function increases an optical length or a size of the illumination optical system, and the entire projector apparatus is hard to be reduced in size, which can be a factor of deteriorating the efficiency. In addition, the white discharge lamp is used for continuous lighting because of the low responsibility, and it is hard to say that this lamp has a long duration of life.

For these reasons, disclosed examples of the projector apparatus which uses a light emitter such as an LED instead of the white discharge lamp have appeared in recent years.

For example, Jpn. Pat. Appln. KOKAI Publication No. 11-32278 discloses an illumination optical system in a projector apparatus which uses an LED as a light source. In this illumination optical system, the outgoing light from an LED array having a bullet-like cap lens attached to each LED chip is converted into the substantially parallel light by a micro-lens which is a condensing optical system corresponding to each LED. Then, the substantially parallel light is converted into a light flux diameter corresponding to a size of an optical modulation element by using an a focal optical system constituted by a combination of a convex lens and a concave lens.

Likewise, U.S. Pat. No. 6,227,669 B1 discloses an example of an illumination apparatus which uses a plurality of light emitters as light sources. This illumination apparatus takes out the output light from light-emitting devices such as a plurality of LED chips by a light distribution lens array which is a condensing optical system corresponding to each light-emitting device. Then, an overlap lens which is called a light convergence lens superimposes light rays from a plurality of the LED chips onto an optical modulation element such as an LCD. This USP describes that a light distribution lens has a function to correct the light distribution irregularities of the light-emitting devices and the uniform illumination with less illumination irregularities is enabled by this function.

### BRIEF SUMMARY OF THE INVENTION

It is an object of the present invention to provide a light-emitting unit which is compact and has the good light efficiency, provide an illumination apparatus which has a long duration of life, high color reproducibility and high efficiency and enables the uniform illumination, and provide a projection display apparatus which is compact and can realize an efficient uniform screen.

According to a first aspect of the present invention, there is provided a light-emitting unit comprising:

one of a light emitter made of a semiconductor and a light emitter which is of an electron exciting type; and

a prism array which is arranged in the vicinity of the front of the light emitter and converts output light rays from the light emitter other than those in a predetermined angle range into light rays in the angle range.

According to a second aspect of the present invention, there is provided an illumination apparatus comprising:

one of a light emitter made of a semiconductor and a light emitter which is of an electron exciting type; and

a light leading member configured to lead light rays which has passed through a first irradiation area which radiates the light rays from the light emitter to a predetermined second irradiation area, the light leading member having an optical structure that the first irradiation area and the second irradiation area are conjugated.

According to a third aspect of the present invention, there is provided a projection display apparatus comprising:

an illumination apparatus including:

a light-emitting unit including:

one of a light emitter made of a semiconductor and a light emitter which is of an electron exciting type; and

a prism array which is arranged in the vicinity of the front of the light emitter and converts output light rays from the light emitter other than those in a predetermined angle range into light rays in the angle range; and

a light leading member configured to lead light rays which have passed through a first irradiation area which radiates the light rays from the prism array to a predetermined second irradiation area, the light leading member having an optical structure that the first irradiation area and the second irradiation area are conjugated;

an optical modulation element which is arranged in the second irradiation area and optically modulates the light rays outgoing from the illumination apparatus; and

a projection optical system which projects the light rays optically modulated by the optical modulation element.

According to a fourth aspect of the present invention, there is provided a light-emitting unit comprising:

one of a light emitter made of a semiconductor and a light emitter which is of an electron exciting type; and

converting means for converting output light rays from the light emitter other than those in a predetermined angle range into light rays in the angle range, the converting means being arranged in the vicinity of the front of the light emitter.

According to a fifth aspect of the present invention, there is provided an illumination apparatus comprising:

one of a light emitter made of a semiconductor and a light emitter which is of an electron exciting type; and

light leading means for leading the light rays which have passed through a first irradiation area which radiates the light rays from the light emitter to a predetermined second irradiation area, the light leading means having an optical structure that the first irradiation area and the second irradiation area are conjugated.

According to a sixth aspect of the present invention, there is provided a projection display apparatus comprising:

an illumination apparatus including:

a light-emitting unit including:

one of a light emitter made of a semiconductor and a light emitter which is of an electron exciting type; and

converting means for converting output light rays from the light emitter other than those in a predetermined angle range into light rays in the angle range, the converting means being arranged in the vicinity of the front of the light emitter; and

light leading means for leading the light rays which have passed through a first irradiation area which radiates the light rays from the converting means to a predetermined second irradiation area, the light leading means having an optical structure that the first irradiation area and the second irradiation area are conjugated;

optical modulating means for optically modulating the light rays outgoing from the illumination apparatus, the optical modulating means being arranged in the second irradiation area; and

projecting means for projecting the light rays optically modulated by the optical modulating means.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a side cross-sectional view showing a prism array used in a light-emitting unit according to a first embodiment of the present invention;

FIG. 2 is a side cross-sectional view showing the light-emitting unit according to the first embodiment;

FIG. 3 is a light path drawing of a prism array;

FIG. 4 is a light distribution characteristic view for illustrating an advantage of the prism array;

FIG. 5 is a side cross-sectional view for illustrating a modification of the light-emitting unit according to the first embodiment;

FIG. 6 is a side cross-sectional view for illustrating another modification of the light-emitting unit according to the first embodiment;

FIG. 7 is a side cross-sectional view for illustrating still another modification of the light-emitting unit according to the first embodiment;

FIG. 8 is a perspective view for illustrating an example of the prism array used in the light-emitting unit according to the first embodiment;

FIG. 9 is a perspective view for illustrating another example of the prism array used in the light-emitting unit according to the first embodiment;

FIG. 10 is a view for illustrating an apparent size in the LED chip oblique arrangement;

FIG. 11 is a view schematically showing an illumination apparatus with a prism array as an example of an illumination apparatus according to a second embodiment of the present invention;

FIG. 12 is a view schematically showing an illumination apparatus having LED chips obliquely arranged as another example of the illumination apparatus according to the second embodiment;

FIG. 13 is a view schematically showing the illumination apparatus with a prism array having LED chips obliquely arranged as still another example of the illumination apparatus according to the second embodiment;

FIG. 14 is a view schematically showing a reflector illumination apparatus with a prism array having LED chips obliquely arranged as yet another example of the illumination apparatus according to the second embodiment;

FIG. 15 is a view typically showing an illumination method of an illumination apparatus according to a third embodiment of the present invention;

FIG. 16 is a view typically showing a modification of the illumination method of the illumination apparatus according to the third embodiment;

FIG. 17 is a view for illustrating each parameter in a calculation formula used to calculate the number of LED chips which can be aligned in the arrangement shown in FIG. 15;

FIG. 18 is a cross-sectional view showing a light ray tracking example provided that a 0.9 inch is a size of an LCD, 1.2 mm is a diagonal length as a size of an LED chip, 0.15 is an allowable NA of the LCD, 0.7 is a fetch NA of a condensing micro-lens, 4 is the number of the LED chips;

FIG. 19 is a view typically showing another modification of the illumination method of the illumination apparatus according to the third embodiment;

FIG. 20 is a view typically showing still another modification of the illumination method of the illumination apparatus according to the third embodiment;

FIG. 21 is a view showing yet another modification of the illumination method of the illumination apparatus according to the third embodiment;

FIG. 22 is a view showing a further modification of the illumination method of the illumination apparatus according to the third embodiment; and

FIG. 23 is an appearance perspective view of a projector as a projection display apparatus according to a fourth embodiment of the present invention.

### DETAILED DESCRIPTION OF THE INVENTION

Preferred embodiments according to the present invention will now be described hereinafter with reference to the accompanying drawings.

### First Embodiment

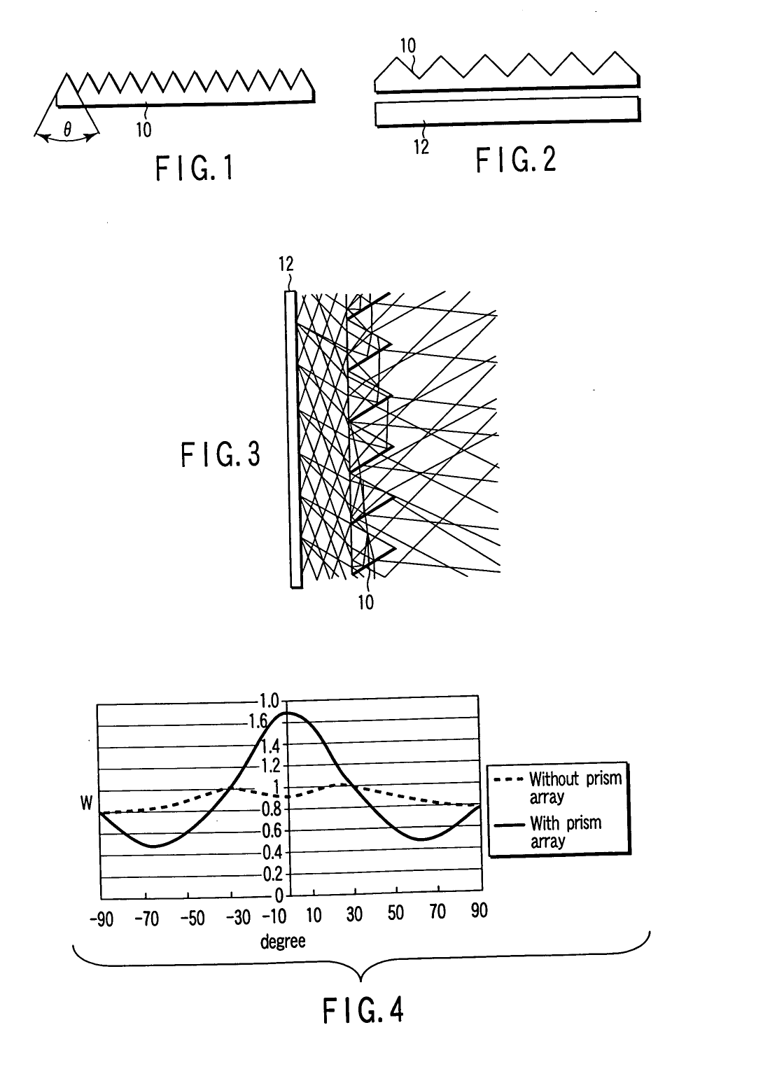

FIG. 1 is a side cross-sectional view of a prism array 10 as converting means used in a light-emitting unit according to a first embodiment of the present invention. This prism array 10 is formed a plurality of prisms that each prism is made of a transparent member having an apex angle θ, and has an effect to convert a spread angle of a light. That is, a spread angle of the output light which has passed through the prism array 10 is dependent on a spread angle of the input light and the apex angle θ.

Such a prism array 10 is, as shown in FIG. 2, arranged in the vicinity of a light-emitting surface of an LED chip 12 as a light-emitting element. By doing so, as shown in FIG. 3, the input light which is the light with a wide spread angle can be converted into the output light having many distributions in a given angle range by an inflection or total reflection phenomenon on the prism surface.

FIG. 4 is a light distribution characteristic view showing in the form of a graph conversion of an angle by drawing a normal line on the right side of a page space from the LED chip 12 in FIG. 3 and determining its angle as 0°. From this graph, it can be understood that the directivity of the LED chip in the vertical direction is improved by arranging the prism array 10 in the vicinity of the LED light-emitting surface. That is, when there is no prism array 10, the energy is provided in a wide angle of approximately 180°. On the other hand, when the prism array 10 is arranged as shown in FIG. 3, the energy in the range of approximately 40° can be increased with a angle having a half value. A side lobe exists in the vicinity of 90° because the light path conversion by the prism array 10 using the light which has been totally reflected on the prism surface or the light originally having a wide angle has less affect.

A light quantity in the range of ±40° is increased by arranging the prism array 10 in this manner. Therefore, in case of improving the directivity by arranging a condensing lens which is a light distribution conversion element at a non-illustrated upper part of a set of the LED chip 12 and the prism array 10 shown in, e.g., FIG. 2, the fetch (condensing) efficiency is improved by using a lens having an NA of 0.65 corresponding to a half angle 40° in accordance with a value obtained by integration using an angle shown in the graph. In this case, more prisms are better, and the pitch is reduced while the number of prisms is increased in such a manner that the prism becomes relatively small with respect to a size of the light-emitting surface of the LED chip 12. If the prism is large as compared with the light-emitting surface, there is the effect equivalent to an effective increase in an area of the light-emitting surface due to inflection by the prism when the condensing lens is arranged at a rear stage of the LED chip 12 and the prism array 10, slanting rays are generated through the condensing lens, which prohibits an improvement in the directivity. On the contrary, when the pitch is too small, the diffraction effect becomes too strong because of a regular structure, and hence the pitch should not be too small. For example, the prism array 10 having 10 prisms with the pitch of 100 μm is provided with respect to the LED chip 12 whose size is 1 mm×1 mm.

The reason of arranging the prism array 10 in the vicinity of the light-emitting surface of the LED chip 12 is as follows. That is, the light having the wide and gentle light distribution characteristic can enter the prism array 10 before spreading and can be subjected to light distribution conversion by shortening a distance of the light emitted from the light to reach the prism array 10, an optical length in the optical axis direction can be shortened, and a surface size of the prism array can be also reduced.

A size of a prism apex angle of the prism array 10 has an influence on the spread angle of the light ray, i.e., the light distribution characteristic of the light-emitting unit comprising the LED chip 12 and the prism array 10. Of course, it also depends on the light distribution characteristic of the LED chip itself, and hence it is important to set an optimum prism apex angle in order to obtain a desired light distribution characteristic in accordance with the light distribution characteristic of the LED chip 12. If the light distribution characteristic of the LED chip 12 has a small angle dependence, the prism apex angle of 60° to 120° can efficiently improve the directivity.

It is to be noted that, as a material of the prism array 10, a transparent optical resin of acrylic or polycarbonate has the good manufacture property as long as it has the resistance against a temperature around the LED chip because the prism array 10 is arranged in the vicinity of the LED chip 12. When a calorific value of the chip is large, however, the prism array 10 made of glass is preferable. Additionally, if an increase in temperature around the chip is considerable when the prism array 10 is arranged in this case, the luminescent efficiency of the LED is deteriorated, and the brightness is degraded. It is, therefore, important to take an arrangement method or a circumferential environment such as a structure or an exhaust into consideration. Further, when the prism array 10 is not arranged in air but in a transparent medium, it is good enough to select a material and determine an apex angle in accordance with a refractive index of the medium.

Furthermore, the above-described directivity improvement effect can be expected when the light emitter is a diffusion light source as well as the LED mentioned above. It is good enough to use an electron exciting light emitter, e.g., a light source which applies a voltage by using an efficient carbon nano-tube as an electron beam source and causes an electron exciting fluorescent material to emit the light. In case of such an electron exciting light emitter, the directivity can be improved by arranging the prism array 10 in the vicinity of the fluorescent material which is the light-emitting surface.

However, an object of the present invention is to provide a light-emitting unit and an illumination apparatus with the excellent efficiency. In that sense, the LED has a restricted light-emitting wavelength band, the high color combination efficiency and the excellent color reproducibility, and hence it is desirable to use the LED rather than the white lamp.

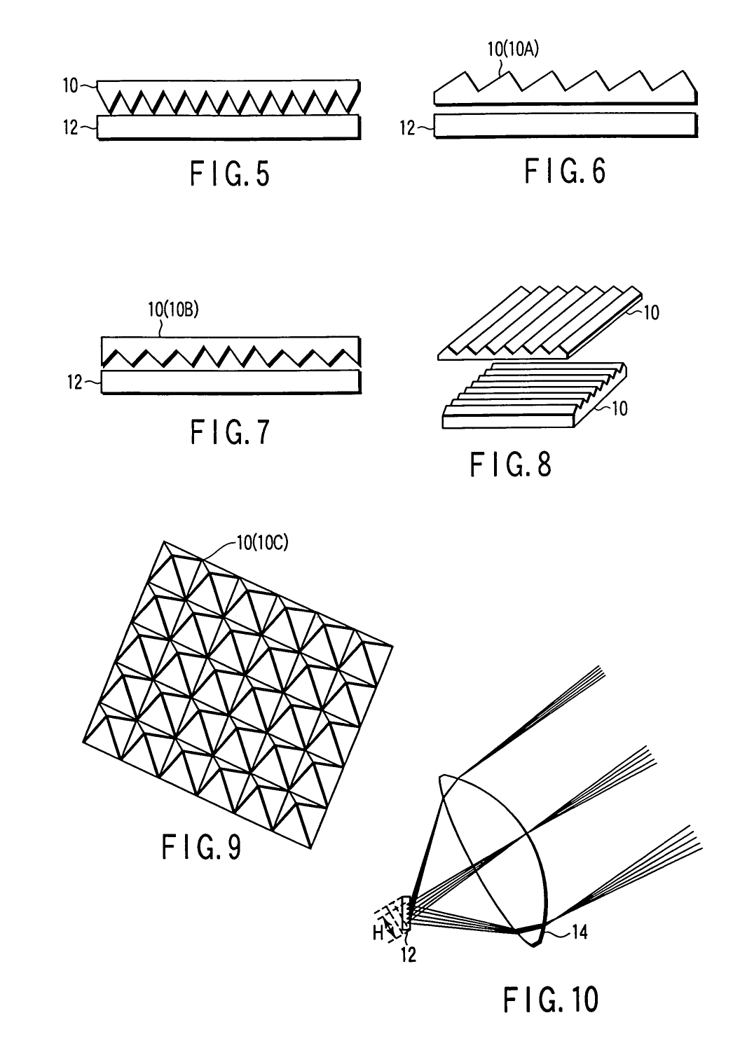

FIG. 5 shows an arrangement example in which a flat surface of the prism array 10 is not opposed to the LED chip 12 but a sharp angle portion of the prism is opposed to the LED chip 12. With such an arrangement, the output light from the set of the LED chip 12 and the prism array 10 can have a light distribution characteristic different from that at the arrangement of FIG. 2, and the outgoing NA of the prism array 10 can be narrowed.

FIG. 6 shows a prism array (prism array 10A) in which each prism has an asymmetrical shape in a page space. With such a structure, there can be obtained a light distribution characteristic that the light distribution characteristic of the output light is not symmetrical in the vertical direction, and hence this structure is effective when the peak should be provided in the oblique direction or when the LED chip 12 is obliquely arranged with respect to the optical system at the rear stage as will be described later.

FIG. 7 shows a prism array 10 (prism array 10B) in which a pitch or an apex angle of each prism is partially changed. This optimizes the apex angle in accordance with irregularities in brightness or irregularities in position of the light distribution characteristic when the LED chip has such irregularities in the chip plane. Although the NA of the outgoing light becomes small as the apex angle becomes sharper, the return light is increased due to total reflection, which deteriorates the efficiency. Here, the LED chip 12 having an in-plane distribution that the brightness at the center is high is assumed, and the prism array has a structure that a high value is set on the outgoing NA rather than the efficiency at the center of the plane and a prism with a sharp angle is arranged and that a high value is set on the efficiency at the periphery and a prism with a more blunt angle than that at the center of the plane is arranged.

The above is the description in one direction in the cross section with reference to the cross-sectional views. Actually, since the light from the LED chip 12 spreads in all directions, a pair of such one-dimensional prism arrays 10 must be arranged in a state that grooves of the prisms are orthogonal to each other or form an angle as shown in FIG. 8. Alternatively, as shown in FIG. 9, it is necessary to arrange one prism array 10 (two-dimensional prism array 10C) having a structure that prisms are formed in a cross section in pyramid-like two directions. A combination of the one-dimensional prism arrays 10 such as shown in FIG. 8 has the good manufacture property of each prism array 10 but, on the other hand, the second prism array is separated from the LED chip 12. Therefore, when the light is condensed by arranging a lens or the like at the rear stage, the light condensing efficiency is deteriorated. On the contrary, in case of the two-dimensional prism array 10C such as shown in FIG. 9, the light distribution characteristic can be efficiently converted by arranging this prism array 10C at a short distance from the LED chip 12.

FIG. 10 shows an arrangement example that the LED chip 12 is inclined with respect to the condensing lens 14, which has been briefly described above. As mentioned above, in case of controlling the directivity by using the optical system such as a condensing lens 14 or the reflecting mirror (reflector), the directivity can be improved by arranging the LED chip 12 in the vicinity of a focal distance of the condensing lens 14 or the reflector. This directivity becomes higher as the chip size is sufficiently smaller with respect to the focal distance or the diameter of the optical system following the chip. Since the LED output light has the light distribution characteristic which has relatively small angle dependence, a light quantity fetched by the condensing lens 14 or the reflector does not hardly vary even if the LED chip is inclined with respect to the condensing lens 14. However, since an apparent size H seen from the condensing lens 14 or the reflector becomes a projection size by inclining it, and the directivity can be thereby increased.

This is effective in the light source whose light arrangement characteristic has less angle dependence. Incidentally, when the light after being condensed and fetched is used as the illumination light, it is preferable to exercise ingenuity to take the eccentric aberration caused by inclining the LED chip 12 in this manner in the optical system provided at a rear stage depending on the illumination method.

### Second Embodiment

An illumination optical system using the LED will now be described as a second embodiment according to the present invention.

FIG. 11 shows an illumination optical system according to this embodiment in which a prism array 10 is arranged immediately behind the LED chip 12. Since a plurality of LED output light rays are superimposed on an LCD 16 as an optical modulation element, there are no irregularities in illumination, and the light efficiency of the illumination optical system is improved by increasing the condensing efficiency of a condensing lens 14 by using the prism array 10. As the prism array 10, an optimum one selected from those shown in FIGS. 2, 5, 6 and 7 is appropriately used in accordance with light leading means, i.e., the condensing lens 14 and overlap lenses 18. Further, a pair of such one-dimensional arrays may be used, or one array formed of pyramid-shaped prisms like the two-dimensional prism array 10C, a polygonal pyramid-shaped prisms or conical-shaped prisms. In case of using two one-dimensional arrays, providing two arrays at a position which is close to the LED chip 12 as much as possible while considering the chip temperature is good for assuring the condensing efficiency of the lens at the rear stage.

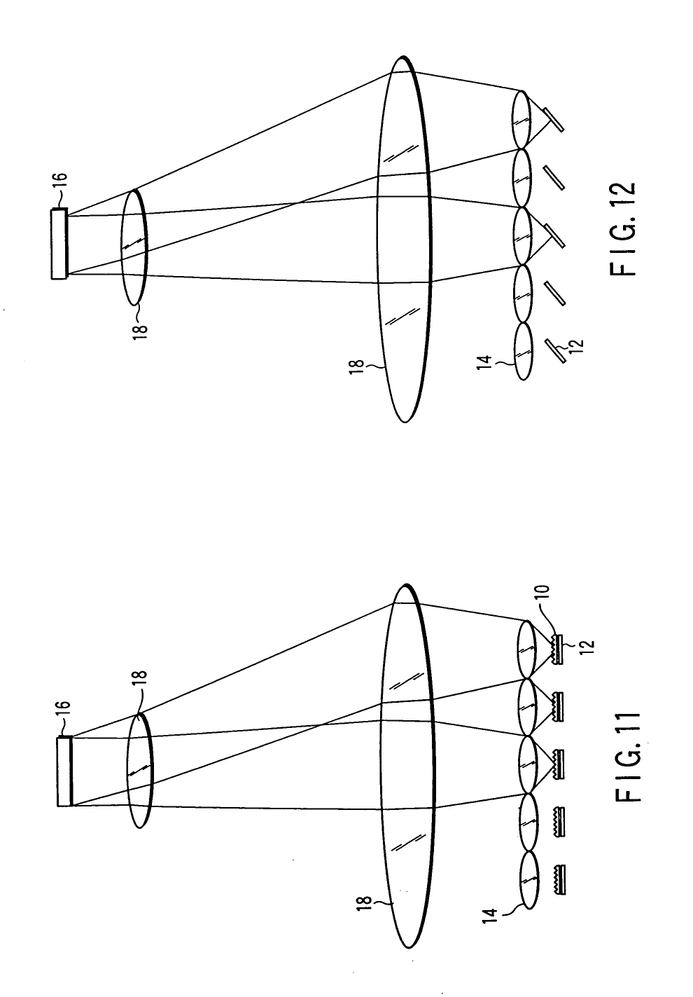

FIG. 12 shows an example of an LED illumination optical system which improves the directivity of the outgoing light from the condensing lens and enhances the light efficiency by providing such an LED chip 12 as shown in FIG. 10 at a slant with respect to the condensing lens 14 at the rear stage. Like FIG. 11, the LCD 16 is arranged at a position of an exit pupil formed by the overlap lenses 18. As will be described later, when the overlap lenses 18 are configured in such a manner that an image of the LED chip 12 is formed on the LCD 16, the LED chip 12 can have an apparent aspect of approximately 4:3 by inclining the LED chip 12 approximately 40° even if the LED chip 12 has, e.g., a regular tetragon having each side of 1 mm and the LCD 16 has an aspect of a rectangle of 4:3, thereby improving the light efficiency.

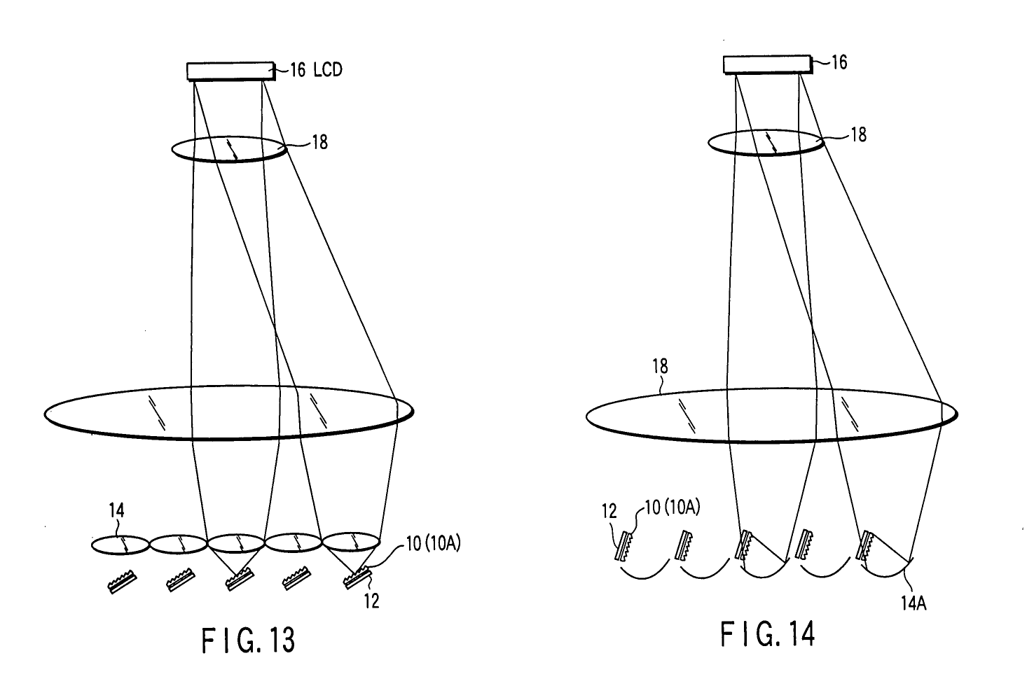

FIG. 13 shows a structural example of the LED illumination optical system in which the LED chip 12 is inclined and the prism array 10 is used. As to the prism array 10, it is preferable to arrange one (prism array 10A) which is of a type having the directivity in the prism such as shown in FIG. 6 in such a manner that the symmetric property of the directivity is increased in accordance with a direction along which the LED chip 12 is inclined and the condensing efficiency of the condensing lens 14 is improved.

FIG. 14 shows as an application of FIG. 13 an illumination optical system which uses as a condensing optical system a reflector 14A constituted by a curved reflecting mirror in place of the condensing lens 14. When using the reflector 14A, the LED chip itself prevents the light, which results in a reduction in the efficiency or a damage to the LED chip 12 itself. Therefore, it is necessary to exercise ingenuity to the arrangement position or the structure of the reflector 14A. Prevention of the light is hardly caused by inclining the LED chip 12 with respect to the reflector 14A and decentering the LED chip 12, and the reflector 14A is also decentered in order to suppress the eccentric aberration in the overlap lenses 18 at the rear stage. As the prism array 10, a non-symmetric type (prism array 10A) such as shown in FIG. 6 is used in order to improve the condensing efficiency of the reflector 14A.

### Third Embodiment

Description will now be given as to an illumination method and a structure using the LED as a third embodiment according to the present invention.

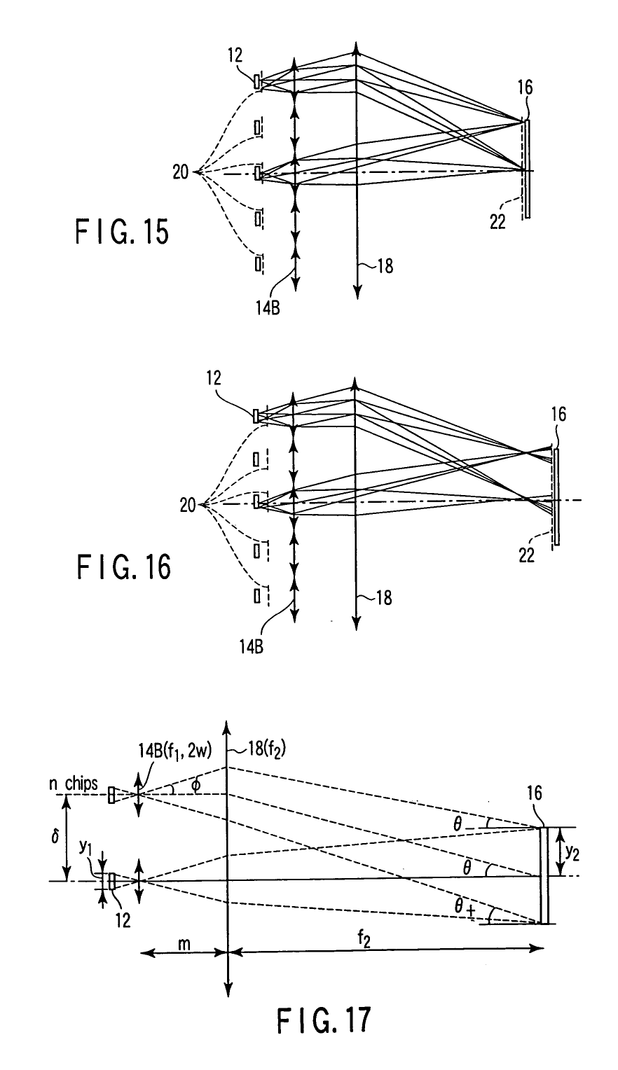

FIG. 15 is a view typically showing an illumination method which forms an image of the LED chip 12 on the LCD 16 as an illuminated object. In this embodiment, a first irradiation area 20 and a second irradiation area 22 which are conjugated with each other are defined, and the optical system has a structure that the first irradiation area 20 is placed in the vicinity of the LED chip 12 and the second irradiation area 22 is placed in the vicinity of an arrangement position of the LCD 16 which is an illuminated object.

That is, the output light rays from the LED chips 12 are condensed by a condensing micro-lens 14B, and the light rays from a plurality of the LED chips 12 are superimposed on the LCD 16, thereby averaging individual differences in brightness between the LED chips 12 and realizing the even illumination. A plurality of the LED chip 12 may be used, or one LED chip 12 can suffice if the brightness is sufficient. Here, when the LED chip 12 and the LCD 16 have the substantially conjugate relationship, the light fetched by the condensing micro-lens 14B can be all ideally led to the LCD 16, and the illumination area incurs no waste, thereby improving the light efficiency. For example, when both the LED chip 12 and the LCD 16 have rectangular shapes, the LCD 16 has a rectangular shape whose aspect is 4:3 and the LED chip 12 also has a rectangular shape whose aspect is 4:3. In such a case, the illumination optical system can have an isotropic lens structure which only gives magnifications, and the illumination light is not supplied to any area other than the display area of the LCD 16, thus improving the illumination efficiency. Of course, when the LCD 16 is a wide screen whose aspect is 16:9, it is preferable that the LED chip 12 also has an aspect of 16:9 in accordance with this.

Alternatively, when the LED chip 12 has a regular tetragon, the illumination efficiency is improved by constituting the condensing micro-lens 14B or the overlap lens 18 as an anamorphic optical system having the vertical power larger than the horizontal power.

Another advantage of providing the conjugate relationship between the LED chip 12 and the LCD 16 is that illumination irregularities are hardly generated even if there is the angle dependence in the light distribution characteristic of the LED chip 12. Further, when there is a distribution of brightness in the LED chip plane, illumination irregularities occur. Actually, the LED chip 12 has an electrode structure for energization, and a bonding wire exists in the chip. Also, the distribution of brightness may be generated in the chip plane in some cases. In such a case, as shown in FIG. 16, it is possible to prevent the shadow of bonding from being led to the illumination irregularities by appropriately defocusing the LCD position from the LED chip image position. That is, in the LED chip 12 and the LCD 16 arranged in the first irradiation area 20 and the second irradiation area 22 having the conjugate relationship as shown in FIG. 15, a blurry image of the LED chip 12 is projected onto the LCD 16 arranged in the second irradiation area 22 by arranging the LED chip 12 at a position shifted from the first irradiation area 20 as shown in FIG. 16, thereby averaging the in-plane brightness distribution.

Description will now be given as to a restriction in the number of the LED chips 12 capable of being arranged which is mathematically derived in accordance with a restriction in an incident angle of the LCD by taking the illumination optical system shown in FIG. 15 as an example.

FIG. 17 is a view typically showing the illumination optical system shown in FIG. 15 in which the LED chip 12 and the LCD 16 as an optical modulation element which is an illuminated object have the conjugate relationship.

When n LED chips 12 are arranged, assuming that θ is a light ray angle entering the LCD 16, 2w is a diameter and f₁ is a focal distance of the condensing micro-lens 14B, f₂ is a focal distance of the overlap lens 18, 2y₁ is an LED chip size, 2y₂ is an LCD size, a normal line running through the center of the LCD 16 is determined as an axis, δ is a distance between the axis and the LED chip 12 which satisfies θ and is arranged at a position away from the axis, φ is an angle of a main light ray of the condensing micro-lens 14B which is emitted from the most peripheral part of the LED chip 12, and m is a distance between main points of the condensing micro-lens 14B and the overlap lens 18, the following expression can be geometrically achieved.

Tan θ=δ/f₂

Tan θ₊=(δ−m·Tan Φ+y₂)/f₂=δ/f₂+(y₂−m·Tan Φ)/f₂

Tan θ₋=(δ+m·Tan Φ−y₂)/f₂=δ/f₂−(y₂−m·Tan Φ,/f₂

δ=nw

f₂/f₁=y₂/y₁=β; Magnification

w/f₁=NA_{LED}

Furthermore, based on a value of m, the following two cases exist.

(1) When m=f₂,

θ₊=θ=θ₋

Here,in order to assure the contrast of the LCD 16, θ must be restricted within a given angle.

∴Tan θ≦NA_{LCD}

θ/f₂≦NA_{LCD}

Therefore, the following expression can be obtained.

n≦(NA_{LCD}·y₂)/(NA_{LED}·y₁) (1)

(2) When m≅0

Here, in order to assure the contrast of the LCD 16, θ must be restricted within a given angle.

∴Tan θ₊≦NA_{LCD}

δ/f₂+y₂/f₂≦NA_{LCD}

nw/2+y₂≦f₁βNA_{LCD}

Based on y₂>0, it complies with the expression (1).

Therefore, the number of the LED chips 12 which can be spatially superimposed, i.e., a light quantity is restricted based on the expression (1). Even if more LED chips 12 than this number are arranged, the allowable NA of the LCD 16 is exceeded, those chips become a factor of degradation of the contrast or illuminate an area other than the surface area of the LCD 16, thereby resulting in the wasteful light.

From the expression (1), the optimum number of the LED chips 12 in a given case can be derived. For example, assuming that the size of the LCD 16 is 0.9, a diagonal length of the LED chip 12 as its size is 1.2 mm, an allowable NA of the LCD 16 is 0.15, a fetch NA of the condensing micro-lens 14B is 0.7, the number of the LED chips 12 which can be arranged in the diagonal direction is approximately four.

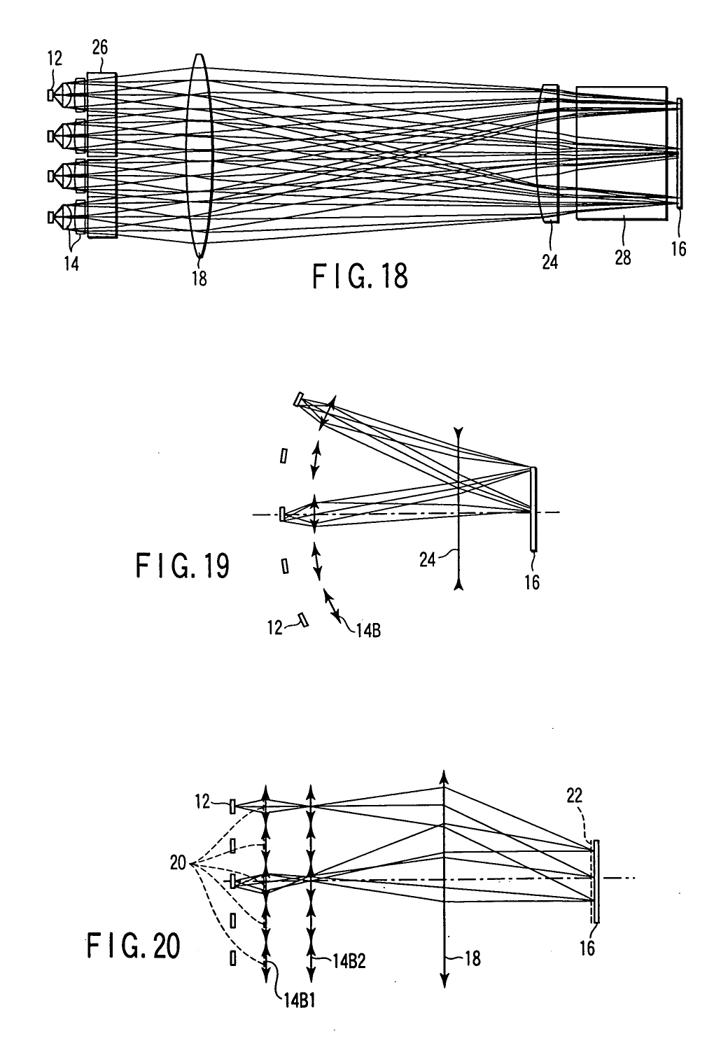

FIG. 18 is a cross-sectional view showing a light ray tracking example based on the above-described numeric values of the LCD illumination optical system in which the LED chip 12 and the LCD 16 have the conjugate relationship. Two condensing lenses 14 are arranged in accordance with each LED chip 12, the light rays are superimposed on the LCD 16 by the overlap lens 18, and a field lens 24 is used to adjust an inclined angle of the main light ray, thereby improving the telecentric property. Although four LED chips 12 are shown, four rows are provided in a direction vertical to a page space, and 4×4, i.e., a total of 16 LED chips 12 are used for illumination. Further, although this drawing is a plan view which does not show the detail, the light rays are converted into substantially parallel light rays by the condensing lens 14, and then they are converted into straight polarized light rays according to the LCD 16 by arranging a polarizing conversion element 26 such as a polarized beam splitter array or a polarizing plate. In order to assure the contrast of the LCD 16 by the output light of the LED chip 12 fetched with the NA 0.7 of the condensing lens 14 on the LED side, the NA on the LCD side is set to 0.15. Images of the respective LED chips 12 are substantially superimposed on the LCD 16, thereby averaging the in-plane irregularities or individual differences in brightness between the respective LED chips 12. Furthermore, since the LED chip 12 and the LCD 16 have the substantially conjugate relationship, there is no wasteful illumination area, and the efficient illumination is realized. It is to be noted that PBS 28 in the drawing is a polarized beam splitter which transmits therethrough the light from the LED chip 12 to the LCD 16 and reflects the reflected light from the LCD 16 toward the non-illustrated projection lens without transmitting it to the LCD chip.

FIG. 19 is a modification of FIG. 15. That is, in FIG. 15, a plurality of the LED chip images are superimposed on the LCD 16 by the overlap lens 18. In FIG. 19, the LED chip 12 and the condensing micro-lens 14B are determined as a set and a plurality of the sets are arranged in a radial pattern. As a result, a plurality of the LED output light rays are superimposed on the LCD 16, thereby performing illumination. The concave lens provided at a front stage of the LCD 16 controls the light ray oblique angle as a filed lens 24.

FIG. 20 shows an example of another illumination method that a plurality of the LED chips 12 are used as light sources. As a condensing member which condenses the light radiated from the LED chips 12, there is provided a two-stage structure including a condensing micro-lens 14B1 and a deflecting micro-lens 14B2 in accordance with each LED chip 12. Further, the LED chip 12 and the LCD 16 as an illuminated object do not have the conjugate relationship, but the condensing micro-lens 14B1 at the front stage of the condensing optical elements in the two-stage structure and the LCD 16 as the illuminated object have the conjugate positional relationship. That is, in the positional relationship of the first irradiation area 20 and the second irradiation area 22 which have the conjugate relationship, there is provided a structure of the optical system that the first irradiation area 20 is placed in the vicinity of the condensing micro-lens 14B1 and the second irradiation area 22 is placed at the LCD 16 as the illuminated object. Further, by placing the condensing micro-lens 14B1 in the vicinity of the front side focal position of the deflecting micro-lens 14B2, an image of each LED chip 12 obtained by the condensing micro-lens 14B1 is positioned in the vicinity of the deflecting micro-lens 14B2. By doing so, the entrance pupil formed on the condensing micro-lens 14B1 can be relayed by using the deflecting micro-lens 14B2 and the overlap lens 18 provided at the rear stage, thereby forming a pupil at the position where the LCD is provided.

Such an illumination method and a structure are advantageous in that individual differences in brightness of the LED chips 12 are averaged by superimposing a plurality of the LED output light rays and hence the uniform illumination can be obtained and that illumination irregularities are hardly generated even if there is a brightness distribution in each LED chip plane because the illuminated object exists on the pupil plane.

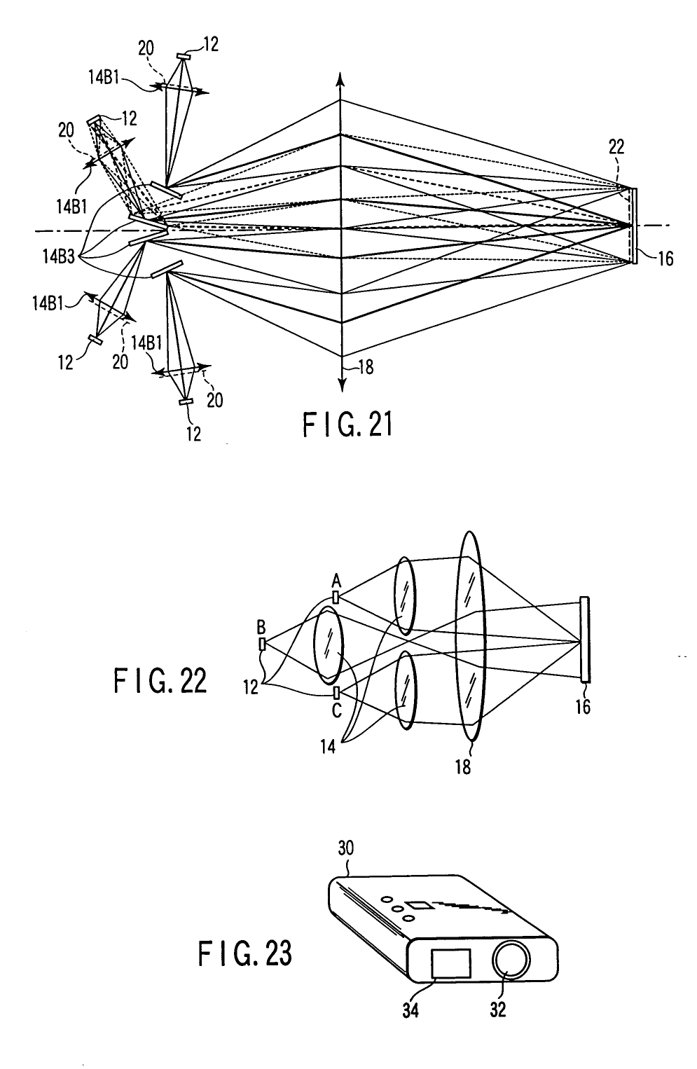

Furthermore, FIG. 21 shows an example of an illumination system which uses a deflecting mirror 14B3 in place of the deflecting micro-lens 14B2 illustrated in FIG. 20. A condensing micro-lens 14B1 and a and a deflecting mirror 14B3 are respectively provided in accordance with each LED chip 12, an overlap lens 18 is arranged so that the condensing micro-lens 14B1 and the LCD 16 have the conjugate positional relationship. The operation of the deflecting mirror 14B3 in this example is to deflect a direction of a light path in such a manner that light rays radiated from the respective LED chips 12 are superimposed on the LCD by the overlap lens 18 through the condensing micro-lens 14B1 without causing prevention of the light rays. A pupil can be likewise efficiently formed at the position where the LCD is provided by the structure of this example, thereby realizing the uniform illumination.

FIG. 22 shows an example of combining the illumination method that the LED is provided in the vicinity of the first irradiation area 20 as shown in FIG. 15 and the illumination method that the condensing micro-lens is provided in the vicinity of the first irradiation area 20 as shown in FIG. 20. This is the example of the illumination method that an illuminated position where the LCD is provided is a pupil plane and also an image plane of the LED chip 12. FIG. 22 shows three pairs A, B and C of the LED chip 12 and the condensing lens 14. Of these pairs, A and C convert the output light rays from the LED chip 12 into substantially parallel light rays by providing each LED chip 12 in the vicinity of the focal distance position of the condensing lens 14 and form an image of the LED chip 12 on the LCD 16 by providing the LCD 16 at the focal distance position of the overlap lens 18. On the other hand, B constitutes a position and a power of the condensing lens 14 so as to form the LED chip image in the vicinity of the condensing lens position of A or C which is provided in the vicinity of the front side focal position of the overlap lens 18, thereby forming a pupil on the LCD 16. This method is advantageous in that, when there are both the brightness distribution in the chip plane and angle irregularities in the light distribution characteristic of the chip output light rays, the uniformity is assured by averaging them. Moreover, by forming another LED chip image between the condensing lenses 14 of A and C, i.e., in a gap between the lenses, the light rays from more LED chips 12 can be spatially superimposed as compared with a case that a pair of the LED chip 12 and the condensing lens 14 are arranged in one direction, i.e., the vertical direction of the page space in the drawing, thereby realizing the bright illumination.

### Fourth Embodiment

FIG. 23 shows an example of a projector apparatus which is a projection type image display apparatus as a fourth embodiment according to the present invention.

This projector apparatus accommodates in a case 30 an illumination apparatus having a light-emitting unit constituted by an LED such as described in connection with the first to third embodiments.

In addition, the illumination apparatus is used to illuminate the optical modulation element such as an LCD 16 having a pixel structure as optical modulating means, and a projection lens 32 as a projecting means is used to enlarge and project the modulated light onto a non-illustrated screen or a white wall surface so that a plurality of people can observed an image. Additionally, by appropriately exhausting the heat in the apparatus by using an air hole 34, the luminescent efficiency of the LED is assured. As a result, the power consumption of the projector apparatus itself can be suppressed by the efficient uniform illumination apparatus, thereby providing a uniform image.

When the LCD is used as the optical modulation element, since there is a blanking interval in a display signal, the LED is also off in that interval, and hence the efficiency is improved as compared with a case that colorization is realized by constantly turning on the white discharge lamp and rotating the color filter in the time division manner or that colorization is realized by providing the color filter in accordance with each pixel. Also, the brightness of black can be suppressed, thereby assuring the contrast.

Although the above has described the present invention based on the embodiments, the present invention is not restricted to the foregoing embodiments, and it is also possible to carry out various kinds of modifications or applications within a scope of the invention.

For example, although not shown, the light-emitting unit or the illumination apparatus according to the present invention can be applied to a rear projector apparatus which folds a light path by bending the light flux emitted from the projection lens to the screen on which an enlarged image is positioned, accommodates in a case all components such as an illumination apparatus including an LED light source, a projection lens, an optical modulation element such as an LCD, a drive circuit for the optical modulation element or the LED, the power supply circuit, and the mirror, and by which an image projected onto the screen provided at the front part of the case can be observed. It is needless to say that a reduction in the power consumption and the uniform screen can be likewise realized in such a rear projector apparatus.

Further, in the foregoing embodiments, although description has been given by taking the LED as an example of the light emitter, a light emitter which is formed by any other semiconductor or which is of an electron exciting type as long as its light distribution characteristic is a characteristic based on a perfect diffuser or a character whose angle dependence is lower than that of the characteristic of the perfect diffuser. Furthermore, although description has been given by taking the LCD as an example of an illuminated object, an application is enabled as long as it is a device which modulates the light, a two-dimensional micro-deflecting mirror array or the like can be used. Moreover, the condensing micro-lens and the LED chip may be integrated as a set or they may be separately provided.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A light-emitting unit comprising:
one of a light emitter made of a semiconductor and a light emitter which is of an electron exciting type; and
a prism array which is arranged in the vicinity of the front of the light emitter and converts output light rays from the light emitter other than those in a predetermined angle range into light rays in the angle range.

2. The light-emitting unit according to claim 1, wherein the prism array has a structure that prisms having one of a polygonal cone shape and a conical shape are arranged.

3. The light-emitting unit according to claim 1, wherein the prism array is constituted by at least two one-dimensional prim arrays.

4. The light-emitting unit according to claim 1, wherein the prism array is arranged in such a manner that its surface on which the prisms are formed is opposed to a light-emitting surface of the light emitter.

5. The light-emitting unit according to claim 1, wherein at least one of sizes and apex angles of the individual prisms are different in the prism array.

6. The light-emitting unit according to claim 1, further comprising a light distribution conversion element configured to condense outgoing light rays from the prism array.

7. The light-emitting unit according to claim 6, wherein the light distribution conversion element condenses only the light rays in the angle range.

8. An illumination apparatus comprising:
one of a light emitter made of a semiconductor and a light emitter which is of an electron exciting type; and
a light leading member configured to lead light rays which has passed through a first irradiation area which radiates the light rays from the light emitter to a predetermined second irradiation area, the light leading member having an optical structure that the first irradiation area and the second irradiation area are conjugated.

9. The illumination apparatus according to claim 8, wherein the light leading member has a condensing optical element which condenses output light rays from the light emitter, and
one of the light emitter arranged in the vicinity of the first irradiation area which restricts light rays to be condensed in the second irradiation area and the condensing optical element has a square shape.

10. The illumination apparatus according to claim 8, wherein the illumination apparatus includes a plurality of the light emitters.

11. The illumination apparatus according to claim 8, wherein a light-emitting surface of the light emitter is arranged in the first irradiation area, and an image is substantially formed in the second irradiation area.

12. The illumination apparatus according to claim 11, wherein a size of the first irradiation area is substantially equal to a size of the light-emitting surface of the light emitter.

13. The illumination apparatus according to claim 11, wherein the light-emitting surface of the light emitter is provided being shifted in a direction vertical to the first irradiation area.

14. The illumination apparatus according to claim 11, wherein the light leading member includes an anamorphic optical system.

15. The illumination apparatus according to claim 11, wherein the light leading member has a condensing optical element which condenses output light rays from the light emitter, and
a normal line of the light-emitting surface of the light emitter and an optical axis of the condensing optical element are arranged so as to form an angle.

16. The illumination apparatus according to claim 8, wherein the light leading member includes:
a condensing member which has a condensing optical element arranged in the vicinity of the first irradiation area and a deflecting optical element arranged in accordance with the condensing optical element, and condenses output light rays from the light emitter; and
an overlap member configured to lead the light rays emitted from the condensing member to the second irradiation area, and
wherein the condensing optical element is arranged in the vicinity of the first irradiation area, and optical pupils are formed in the first irradiation area and the second irradiation area.

17. The illumination apparatus according to claim 8, further comprising:
a prism array which is arranged in the vicinity of the front of the light emitter and converts output light rays from the light emitter other than those in a predetermined angle range into light rays in the angle range.

18. The illumination apparatus according to claim 17, wherein the prism array has a structure that prisms having one of a polygonal cone shape and a conical shape are arranged.

19. The illumination apparatus according to claim 17, wherein the prism array is constituted by at least two one-dimensional prism arrays.

20. The illumination apparatus according to claim 17, wherein a surface of the prism array on which the prisms are formed are arranged so as to be opposed to the light-emitting surface of the light emitter.

21. A projection display apparatus comprising:
an illumination apparatus including:
a light-emitting unit including:
one of a light emitter made of a semiconductor and a light emitter which is of an electron exciting type; and
a prism array which is arranged in the vicinity of the front of the light emitter and converts output light rays from the light emitter other than those in a predetermined angle range into light rays in the angle range; and
a light leading member configured to lead light rays which have passed through a first irradiation area which radiates the light rays from the prism array to a predetermined second irradiation area, the light leading member having an optical structure that the first irradiation area and the second irradiation area are conjugated;
an optical modulation element which is arranged in the second irradiation area and optically modulates the light rays outgoing from the illumination apparatus; and
a projection optical system which projects the light rays optically modulated by the optical modulation element.

22. The projection display apparatus according to claim 21, wherein a shape of the light-emitting surface of the light emitter is similar to a shape of the optical modulation element.

23. A light-emitting unit comprising:
one of a light emitter made of a semiconductor and a light emitter which is of an electron exciting type; and
converting means for converting output light rays from the light emitter other than those in a predetermined angle range into light rays in the angle range, the converting means being arranged in the vicinity of the front of the light emitter.

24. An illumination apparatus comprising:
one of a light emitter made of a semiconductor and a light emitter which is of an electron exciting type; and
light leading means for leading the light rays which have passed through a first irradiation area which radiates the light rays from the light emitter to a predetermined second irradiation area, the light leading means having an optical structure that the first irradiation area and the second irradiation area are conjugated.

25. The illumination apparatus according to claim 24, further comprising:
converting means for converting output light rays from the light emitter other than those in a predetermined angle range into light rays in the angle range, the converting means being arranged in the vicinity of the front of the light emitter.

26. A projection display apparatus comprising:
an illumination apparatus including:
a light-emitting unit including:
one of a light emitter made of a semiconductor and a light emitter which is of an electron exciting type; and
converting means for converting output light rays from the light emitter other than those in a predetermined angle range into light rays in the angle range, the converting means being arranged in the vicinity of the front of the light emitter; and
light leading means for leading the light rays which have passed through a first irradiation area which radiates the light rays from the converting means to a predetermined second irradiation area, the light leading means having an optical structure that the first irradiation area and the second irradiation area are conjugated;
optical modulating means for optically modulating the light rays outgoing from the illumination apparatus, the optical modulating means being arranged in the second irradiation area; and
projecting means for projecting the light rays optically modulated by the optical modulating means.
